(19) United States
(12) Patent Application Publication
(10) Pub. No.: US 2023/0420762 A1
(43) Pub. Date: Dec. 28, 2023

(54) FLUIDIZED BED REACTOR AND METHOD FOR RECYCLING LITHIUM PRECURSOR USING SAME

(71) Applicant: SK INNOVATION CO., LTD., Seoul (KR)

(72) Inventors: Min Ji SUNG, Daejeon (KR); Ye Rhee CHA, Daejeon (KR); Sung Real SON, Daejeon (KR); Ji Min KIM, Daejeon (KR); Young Bin SEO, Daejeon (KR); Hyeon Bae HA, Daejeon (KR)

(21) Appl. No.: 18/464,894

(22) Filed: Sep. 11, 2023

Related U.S. Application Data
(63) Continuation of application No. PCT/KR2022/003358, filed on Mar. 10, 2022.

(30) Foreign Application Priority Data
Mar. 11, 2021 (KR) 10-2021-0031909

(51) Int. Cl. H01M 10/54; C01D 15/02; C01D 15/08; B01J 8/18

(52) U.S. Cl. CPC H01M 10/54; C01D 15/02; C01D 15/08; B01J 8/1827; C01P 2004/61

(57) ABSTRACT

In a method for recycling a lithium precursor of the present invention, cathode active material powders including lithium composite oxide particles and having different particle sizes are prepared. A preliminary precursor mixture is prepared by reducing the cathode active material powders in a fluidized bed reactor including a reactor body whose cross-sectional diameter is decreased stepwise or gradually from an upper portion to a lower portion. Subsequently, a lithium precursor is recovered from the preliminary precursor mixture.

### CROSS-REFERENCE TO RELATED APPLICATION

This application is a bypass continuation application of PCT/KR2022/003358 filed on Mar. 10, 2022, which claims priority to KR 10-2021-0031909 filed on Mar. 11, 2021. The disclosure of each of the foregoing applications is incorporated herein by reference in its entirety.

### TECHNICAL FIELD

The present invention relates to a fluidized bed reactor and a method for recycling a lithium precursor using the same. More specifically, the present invention relates to a fluidized bed reactor and a method using the fluidized bed reactor for recycling a lithium precursor from a waste lithium-containing compound.

### BACKGROUND ART

A secondary battery can be repeatedly charged and discharged, and is widely used as power source for portable electronic communication devices such as camcorders, mobile phones, and laptop computers with the development of information communication and display industries. Battery packs comprising a plurality of secondary batteries are also used for hybrid and electric vehicles. Examples of secondary batteries include a lithium secondary battery, a nickel-cadmium battery, a nickel-hydrogen battery and the like. The lithium secondary battery has a high operating voltage and a high energy density per unit weight, and is advantageous in terms of a charging speed and light weight. As a result, the lithium secondary battery has been actively developed and applied as a power source for electronic and electric devices including hybrid and electric vehicles.

The lithium secondary battery may include: an electrode assembly including a cathode, an anode, and a separation membrane (separator); and an electrolyte in which the electrode assembly is impregnated. In addition, the lithium secondary battery may further include, for example, a pouch-shaped outer case in which the electrode assembly and the electrolyte are housed.

A lithium metal oxide may be used as a cathode active material for the lithium secondary battery. The lithium metal oxide may further contain transition metals such as nickel, cobalt, or manganese.

The lithium composite oxide as the cathode active material may be prepared by reacting a lithium precursor with a nickel-cobalt-manganese (NCM) precursor containing nickel, cobalt and manganese.

As the above-described expensive valuable metals are used for the cathode active material, 20% or more of manufacturing costs of the lithium secondary battery is required to manufacture the cathode material. Recently, because of environmental concerns, research for developing improved methods for recovering the cathode active material and the precious metals of the cathode active material is being conducted. In order to recycle the cathode active material, it is necessary to recycle the lithium precursor from a waste cathode with high efficiency and high purity.

### SUMMARY OF THE INVENTION

An object of the present invention is to provide a fluidized bed reactor for recovering a high purity lithium precursor with high yield from a lithium-containing compound and a method for recycling a lithium precursor using the same.

A method for recycling a lithium precursor includes preparing cathode active material powder including lithium composite oxide particles and having different particle sizes, preparing a preliminary precursor mixture by reducing the cathode active material powder in a fluidized bed reactor. The fluidized bed reactor may comprise a reactor body having a cross-sectional diameter which decreases from an upper portion to a lower portion of the fluidized bed. The method further comprises recovering the lithium precursor formed in the fluidized bed reactor from the preliminary precursor mixture.

In example embodiments, the cathode active material powder may include a first active material powder, a second active material powder, and a third active material powder, which have different particle sizes, and the reactor body may include a first region where the first active material powder is fluidized, a second region where the second active material powder is fluidized, and a third region where the third active material powder is fluidized.

In example embodiments, the first region, the second region, and the third region may be sequentially disposed from the upper portion of the reactor body.

In example embodiments, a cross-sectional diameter of the first region may be greater than a cross-sectional diameter of the second region, and the cross-sectional diameter of the second region may be greater than a cross-sectional diameter of the third region.

In example embodiments, a ratio of the cross-sectional diameter of the first region to the cross-sectional diameter of the third region may be 4 to 16.

In example embodiments, a ratio of the cross-sectional diameter of the second region to the cross-sectional diameter of the third region may be 2 to 4.

In example embodiments, the particle size of the first active material powder may be smaller than that of the second active material powder, and the particle size of the second active material powder may be smaller than that of the third active material powder.

In example embodiments, the particle size of the first active material powder may be less than 10 μm, the particle size of the second active material powder may be 10 to 100 μm, and the particle size of the third active material powder may be 100 μm or more.

In example embodiments, preparing the preliminary precursor mixture may further include injecting a reducing gas into the fluidized bed reactor.

In example embodiments, a minimum flow velocity of the reducing gas in the first region may be a terminal velocity or less of the first active material powder.

In example embodiments, a maximum flow velocity of the reducing gas in the second region may be a minimum fluidization rate or more of the second active material powder, and a maximum flow velocity of the reducing gas in the third region may be a minimum fluidization rate or more of the third active material powder.

In example embodiments, the reducing gas may be injected into the fluidized bed reactor at a flow velocity of 8 to 18 cm/s or 10 to 16 cm/s, or 12 to 14 cm/s.

In example embodiments, the fluidized bed reactor may include: a first connection section which connects the first region and the second region, and has a cross-sectional diameter decreasing from the first region to the second region; and a second connection section which connects the second region and the third region, and has a cross-sectional diameter decreasing from the second region to the third region.

In example embodiments, the first connection section and the second connection section may further each include one or more gas injection ports, and preferably a plurality of gas injection ports disposed on side surfaces thereof.

In example embodiments, the gas injection ports may be disposed on the side surface of the reactor body. The gas injection ports may be inclined upward.

In example embodiments, an angle formed by the side surfaces of the first connection section and the second connection section and the gas injection ports may be to 90° or 45° to 80°, or 50° to 70°. This angle is also referred to as the gas injection port angle and is the angle formed between a gas injection port and the side surface of the first or second connection section.

According to another aspect of the present invention, there is provided a fluidized bed reactor adapted for reducing a cathode active material, the fluidized bed reactor including: a reactor body whose cross-sectional diameter is decreased stepwise or gradually from an upper portion to a lower portion; an active material inlet through which a plurality of cathode active material powders including lithium composite oxide particles and having different particle sizes are injected into the reactor body; and a gas inlet located at the lower portion of the reactor body and into which a reducing gas for fluidizing the active material powder is injected.

In example embodiments, the fluidized bed reactor for reducing a cathode active material of the present invention may include a first connection section which connects the first region and the second region, and has a cross-sectional diameter decreasing from the first region to the second region; and a second connection section which connects the second region and the third region, and has a cross-sectional diameter decreasing from the second region to the third region.

In example embodiments, the first connection section and the second connection section may further include gas injection ports disposed on side surfaces thereof. Effects of the Invention

According to the above-described example embodiments, the method for recycling a lithium precursor of the present invention may reduce active material powders having different particle sizes in a fluidized bed reactor including a reactor body whose cross-sectional diameter is decreased stepwise or gradually from an upper portion to a lower portion. Accordingly, it is possible to more easily obtain a high purity lithium precursor with high yield.

In addition, as the reactor has regions with different cross-sectional diameters, temperature deviation according to the position in the reactor may be decreased. Accordingly, fluidization of the cathode active material particles may be smoothly performed to implement uniform mixing/reduction throughout the reactor.

In addition, the fluidized bed reactor may further include gas injection ports on side surfaces thereof. The gas injection ports may prevent the active material powder from being deposited on the side surfaces of the fluidized bed reactor. Accordingly, recovery efficiency of the lithium precursor may be further improved.

### BRIEF DESCRIPTION OF DRAWINGS

FIG. 1 is a schematic flowchart for describing a method for recycling a lithium precursor according to example embodiments of the present invention.

FIGS. 2 and 3 are schematic views illustrating a fluidized bed reactor for reducing a cathode active material according to example embodiments of the present invention.

### DETAILED DESCRIPTION OF EMBODIMENTS FOR PRACTICING THE INVENTION

Embodiments of the present invention recover a lithium precursor from a cathode active material by using a fluidized bed reactor including a reactor body whose cross-sectional diameter is decreased stepwise or gradually from an upper portion to a lower portion. Accordingly, recovery efficiency of the lithium precursor may be further improved.

Hereinafter, example embodiments of the present invention will be described in detail with reference to the accompanying drawings. However, these embodiments are merely provided as examples, and the present invention is not limited to the specific embodiments described.

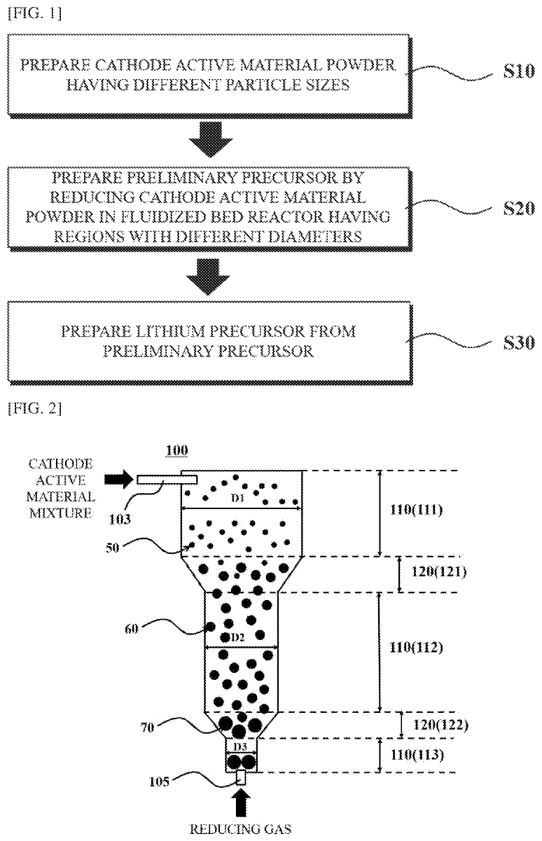

FIG. 1 is a schematic flowchart for describing a method for recycling a lithium precursor according to example embodiments of the present invention.

According to example embodiments, cathode active material powders including lithium composite oxide particles and having different particle sizes may be prepared e.g., in operation S10.

The cathode active material powder may include lithium composite oxide particles obtained or recycled from the active cathode materials of cathodes of electric, electronic, or other devices using lithium composite oxide particles. Such devices may also be chemical devices such as ______. The cathode active material powder may include various lithium composite oxide particles such as lithium oxide, lithium carbonate, lithium hydroxide and the like.

The cathode active material powder may include lithium composite oxide particles obtained or recycled from a waste lithium secondary battery. The waste lithium secondary battery may include an electrode assembly including a cathode, an anode, and a separation membrane interposed between the cathode and the anode. The cathode and anode may include a cathode active material layer and an anode active material layer, which are coated on a cathode current collector and an anode current collector, respectively.

For example, the cathode active material included in the cathode active material layer may include lithium composite oxide particles containing lithium and transition metals.

In some embodiments, the cathode active material may include lithium composite oxide particles represented by Formula 1 below.

LiₓM1ₐM2_{b}M3_{c}O_{y} Formula 1

In Formula 1, M1, M2 and M3 may be a transition metal selected from Ni, Co, Mn, Na, Mg, Ca, Ti, V, Cr, Cu, Zn, Ge, Sr, Ag, Ba, Zr, Nb, Mo, Al, Ga or B. In Formula 1, 0<x≤1.2, 2≤y≤2.2, 0<a<1, 0<b<1, 0<c<1, 0<a+b+c<1.

In some embodiments, the cathode active material may include NCM-based lithium composite oxide particles including nickel, cobalt and manganese. The NCM-based lithium composite oxide may be prepared by reacting a lithium precursor and a NCM precursor (e.g., NCM oxide) with each other through a co-precipitation reaction.

However, embodiments of the present invention may be commonly applied to a lithium composite oxide cathode material containing lithium, as well as the cathode material including the NCM-based lithium composite oxide particles.

For example, the cathode may be separated and recovered from the waste lithium secondary battery. The cathode includes the cathode current collector (e.g., aluminum (Al)) and the cathode active material layer as described above, and the cathode active material layer may include a conductive material and a binder together with the above-described cathode active material.

The conductive material may include, for example, a carbon-based material such as graphite, carbon black, graphene, carbon nanotube or the like.

The binder may include, for example, a resin material such as vinylidene fluoride-hexafluoropropylene copolymer (PVDF-co-HFP), polyvinylidene fluoride (PVDF), polyacrylonitrile, polymethyl methacrylate or the like.

In some example embodiments, the cathode active material powder may be prepared by separating a cathode from the waste lithium secondary lithium battery and pulverizing the separated cathode.

For example, the pulverization may be performed using a hammer mill, a shredder, a cut crusher, an impact crusher or the like. In this case, the cathode active material powder may be prepared in a powder form by the pulverization, and the cathode active material powder may include particles having different particle sizes.

For example, the cathode active material powder may have a multimodal particle size distribution. For example, the multimodal particle size distribution may refer to a case in which there are a plurality of main peaks in a particle size distribution chart of particles. In this case, the particle size of the cathode active material powder may be about 1 to 100 μm.

For example, the cathode active material powder may include a first active material powder, a second active material powder, and a third active material powder, which have different particle sizes. For example, the particle size of the first active material powder may be smaller than that of the second active material powder, and the particle size of the second active material powder may be smaller than that of the third active material powder.

For example, particles having a particle size of less than about 10 μm included in the cathode active material powder may be defined as the first active material powder, particles having a particle size of about 10 to 100 μm may be defined as the second active material powder, and particles having a particle size of about 100 μm or more may be defined as the third active material powder.

In some embodiments, the recovered cathode may be subjected to heat treatment before the pulverization. Accordingly, desorption of the cathode current collector may be facilitated during the pulverization treatment, and the binder and the conductive material may be at least partially removed. The heat treatment temperature may be, for example, about 100° C. to 500° C., and preferably about 350° C. to 450° C.

For example, the cathode current collector may be removed by immersing the separated cathode in an organic solvent. The cathode current collector may be removed from the separated cathode through centrifugation, and the cathode active material mixture may be selectively extracted by removing the cathode current collector.

Through the above-described processes, it is possible to obtain the cathode active material mixture in which a cathode current collector component such as aluminum is substantially completely separated and removed, and contents of carbon-based components derived from the carbon-based conductive material and the binder are removed or reduced.

According to example embodiments, a preliminary precursor mixture may be prepared from the cathode active material powder according to operation step S20.

In some embodiments, a preliminary precursor mixture may be prepared by hydrogen reducing the cathode active material powder. For example, the hydrogen reduction treatment may be performed in a fluidized bed reactor. The fluidized bed reactor may include a reactor body having a cross-sectional diameter which decreases from an upper portion to a lower portion. The cross-sectional diameter may decrease stepwise or gradually from an upper portion to a lower portion of the fluidized bed reactor. The cathode active material powder may be introduced into the fluidized bed reactor form one or more ports. The cathode active material powder may be introduced into the fluidized bed reactor from one or more upper ports, i.e., ports positioned at an upper portion of the fluidized bed reactor. A reducing gas may be injected from one or more ports in the lower portion of the fluidized bed reactor. For example, the reducing gas may be a hydrogen gas. The structure of the fluidized bed reactor and reactions in the fluidized bed reactor will be described below.

The reducing gas introduced from the lower portion of the fluidized bed reactor may move in a cyclonic or swirling pattern lifting the active material powder and suspending it inside the fluidized bed gas reactor. A preliminary precursor mixture may be generated by the reduction of the active material powder while it comes into contact with the hydrogen gas.

A carrier gas together with the reducing gas may be mixed and injected into the lower portion of the fluidized bed reactor. Accordingly, the fluidized bed may enhance gas-solid mixing to facilitate a reaction, and a reaction layer of the preliminary precursor mixture may be easily formed in the fluidized bed reactor. The carrier gas may include, for example, an inert gas such as nitrogen (N2) or argon (Ar).

The preliminary precursor mixture may include a hydrogen reduction reactant of lithium-transition metal oxide included in the active material powder. When an NCM-based lithium oxide is used as the lithium-transition metal oxide, the preliminary precursor mixture may include a preliminary lithium precursor and a transition metal-containing reactant.

The preliminary lithium precursor may include lithium hydroxide, lithium oxide and/or lithium carbonate. According to example embodiments, since the preliminary lithium precursor is obtained through a hydrogen reduction reaction, the mixed content of lithium carbonate may be reduced.

The transition metal-containing reactant may include Ni, Co, NiO, CoO, MnO and the like.

The hydrogen reduction reaction may be performed at about 400° C. to 700° C., and preferably 450° C. to 550° C.

According to example embodiments, after collecting the preliminary precursor mixture, water washing treatment may be performed (e.g., operation S30).

By the water washing treatment, the preliminary lithium precursor may be converted into a lithium precursor substantially composed of lithium hydroxide. For example, lithium oxide and lithium carbonate incorporated into the preliminary lithium precursor may be converted into lithium hydroxide by reacting with water or may be removed by washing with water. Therefore, a high purity lithium precursor converted into a desired form of lithium hydroxide may be produced.

The preliminary lithium precursor may be dissolved by reacting with water to substantially prepare an aqueous solution of lithium hydroxide.

The transition metal-containing reactant included in the preliminary precursor mixture may be precipitated without dissolving in or reacting with water by the water washing treatment. Therefore, the transition metal-containing reactant may be separated by filtration to obtain a lithium precursor including a high purity lithium hydroxide.

In some embodiments, the water washing treatment may be performed under conditions in which carbon dioxide (CO₂) is excluded. For example, since the water washing treatment is performed in a CO₂-free atmosphere (e.g., an air atmosphere from which CO₂ is removed), regeneration of lithium carbonate may be prevented.

In one embodiment, CO₂-free atmosphere may be created by purging (e.g., nitrogen purging) water provided during the water washing treatment using a CO₂ deficient gas.

In some embodiments, the precipitated, separated transition metal-containing reactant may be treated with an acid solution to form precursors in the form of acid salts of each transition metal. In one embodiment, sulfuric acid may be used as the acid solution. In this case, NiSO₄, MnSO₄ and CoSO₄ may be recovered as the transition metal precursor, respectively.

As described above, the preliminary precursor mixture produced by hydrogen reduction may be treated with water to obtain a lithium precursor substantially composed of lithium hydroxide. Therefore, it is possible to obtain a cathode active material having a higher capacity and a longer life-span by preventing by-product generation of other types of lithium precursors such as lithium carbonate.

The lithium precursor may include lithium hydroxide (LiOH), lithium oxide (Li₂O), or lithium carbonate (Li₂CO₃). In terms of charge/discharge characteristics, life-span characteristics, and high-temperature stability of the lithium secondary battery, the lithium hydroxide may be advantageous as the lithium precursor. For example, the lithium carbonate may cause a deposition reaction on the separation membrane, thereby deteriorating the life-span stability.

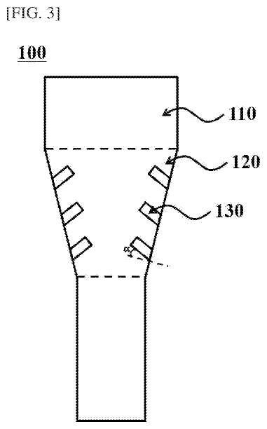

FIGS. 2 and 3 are schematic views illustrating a fluidized bed reactor for reducing a cathode active material according to example embodiments of the present invention.

Referring to FIG. 2, a fluidized bed reactor 100 for reducing a cathode active material of the present invention may include: a reactor body 110 whose cross-sectional diameter is decreased stepwise or gradually from an upper portion to a lower portion; an active material inlet 103 through which a plurality of active material powders 50, 60 and including lithium composite oxide particles and having different particle sizes are injected into the reactor body 110; and a gas inlet 105 located at the lower portion of the reactor body 110 and into which a reducing gas for fluidizing the active material powders 60 and 70 is injected.

According to some example embodiments, the cathode active material powders 60 and 70 may include a first active material powder 50, a second active material powder 60, and a third active material powder 70, which have different particle sizes.

For example, within the reactor body 110, the plurality of active material powders 50, 60 and 70 may be fluidized, respectively. For example, the reactor body 110 may include a plurality of regions having different cross-sectional diameters in which the plurality of active material powders 50, 60 and 70 are fluidized, respectively.

For example, the third active material powder 70 having a large particle size may be fluidized in the lower portion of the reactor body 110, and the first active material powder 50 having a small particle size may be fluidized in the upper portion of the reactor body 110.

According to some embodiments, the reactor body 110 may include: a first region 111 where the first active material powder 50 is fluidized; a second region 112 where the second active material powder 60 is fluidized; and a third region 113 where the third active material powder 70 is fluidized.

Accordingly, during fluidizing the cathode active material mixture including a plurality of active material powders having different particle sizes, it is possible to effectively prevent problems in which active material powders having small particle sizes are scattered and leaked, or active material powders having large particle sizes are not sufficiently fluidized.

In addition, as the reactor has regions with different cross-sectional diameters, the temperature deviation according to the position in the reactor may be decreased. Accordingly, fluidization of the cathode active material particles may be smoothly performed to implement uniform mixing throughout the reactor. Thereby, excellent reaction efficiency may be implemented even for particle mixtures having different particle size distributions.

For example, a cross-sectional diameter D1 the first region 111 may be greater than a cross-sectional diameter D2 of the second region 112, and the cross-sectional diameter D2 of the second region 112 may be greater than a cross-sectional diameter D3 of the third region 113.

In this case, the particle size of the first active material powder 50 fluidized in the first region 111 may be smaller than that of the second active material powder 60 fluidized in the second region 112, and the particle size of the second active material powder 60 fluidized in the second region 112 may be smaller than that of the third active material powder 70 fluidized in the third region 113.

For example, a flow velocity of the reducing gas injected into the fluidized bed reactor may be inversely proportional to the square of the cross-sectional diameter of each region. Therefore, the flow velocity of the reducing gas may be slower in the first region 111 than in the second region 112, and may be slower in the second region 112 than in the third region 113. Accordingly, in the first region 111, the first active material powder having a small particle size may be easily fluidized, and in the third region 113, the third active material powder 70 having a large particle size may be easily fluidized.

According to some example embodiments, a ratio of the cross-sectional diameter D1 of the first region 111 to the cross-sectional diameter D3 of the third region 113 may be 5 to 10. For example, a ratio of the cross-sectional diameter D2 of the second region 112 to the cross-sectional diameter D3 of the third region 113 may be 2 to 4.

For example, when satisfying the above diameter ratio range, fluidization of each of the first active material powder 50, the second active material powder 60, and the third active material powder 70 may be more easily performed. Accordingly, recovery efficiency of the lithium precursor may be further improved.

According to some example embodiments, the first region 111, the second region 112, and the third region 113 may be sequentially disposed from the upper portion of the reactor body 110. In this case, the reducing gas may be injected from the lower portion to the upper portion of the reactor body 110. Thereby, the cross-sectional diameter of each region may be decreased from the upper portion toward the lower portion of the reactor body 110.

For example, as the cross-sectional diameter of the reactor body 110 is decreased from the upper portion toward the lower portion, the flow velocity of the reducing gas injected into the lower portion of the reactor body 110 may be decreased from the lower portion toward the upper portion. Accordingly, the first active material powder 50 having a small particle size may be fluidized in the first region 111 having a large diameter, and the third active material powder 70 having a large particle size may be fluidized in the third region 113 having a small diameter.

Thereby, during fluidizing the cathode active material mixture, it is possible to effectively prevent problems in which the recovery efficiency of the lithium precursor is reduced due to scattering of the active material powder having a small particle size or failure to fluidize the active material powder having a large particle size.

For example, the gas inlet 105 is located at the lower portion of the reactor body 110, and the reducing gas may be injected through this inlet. The reducing gas may include, for example, the hydrogen gas. For example, the reducing gas may be injected into the lower portion of the reactor body 110 to fluidize and reduce the cathode active material mixture included inside the reactor body 110.

For example, a minimum fluidization rate to be described below may refer to the minimum flow velocity of the reducing gas for fluidizing the cathode active material powders 50, 60 and 70. For example, the minimum fluidization rate may be calculated through the following Equation 1:

$$\frac{1.75}{{ε}_{mf}^{3} {φ}_{s}} {( \frac{{d}_{p} {u}_{mf} {ρ}_{g}}{μ} )}^{2} + \frac{150 ( 1 - {ε}_{mf} )}{{ε}_{mf}^{3} {φ}_{s}^{2}} ( \frac{{d}_{p} {u}_{mf} {ρ}_{g}}{μ} ) = \frac{{d}_{p}^{3} {ρ}_{g} ( {ρ}_{s} - {ρ}_{g} ) g}{{μ}^{2}} \qquad Equation 1$$

In Equation 1, u_{mf} a may be the minimum fluidization rate, ε_{mf} may be a volume fraction of the active material powder particles, dₚ may be a size of the active material powder particles, ρ_{g} may be a gas density of the reducing gas, ρₛ may be a solid density of the active material powder particles, μ may be a gas viscosity of the reducing gas, φₛ may be a sphericity of the active material powder particles, and g may be an acceleration of gravity.

For example, the flow velocity of the reducing gas within the fluidized bed reactor 100 may vary depending on the cross-sectional diameter of the reactor body 110 included in the fluidized bed reactor 100. For example, the flow velocity of the reducing gas may be decreased as the cross-sectional diameter of the reactor body 110 is increased.

In some example embodiments, the minimum flow velocity of the reducing gas in the first region 111 may be the one corresponding to the terminal velocity or less of the first active material powder 50. For example, the terminal velocity may refer to a velocity in a state where an object moves at a constant speed when descending or moving in a fluid.

For example, the terminal velocity may be calculated through Equation 2 below.

$${u}_{t} = {[ \frac{18}{{d}_{p}^{2}} + \frac{2.335 - 1.744 {φ}_{s}}{{d}_{p}^{0.5}} ]}^{- 1} \qquad Equation 2$$

In Equation 2, uₜ may be the terminal velocity, dₚ may be the size of the active material powder particles, and cps may be the sphericity of the active material powder particles.

When the minimum flow velocity of the reducing gas in the first region 111 is reduced to correspond to the terminal velocity or less of the first active material powder 50, it is possible to effectively prevent the problem in which the first active material powder 50 having a relatively small particle size is scattered. In addition, as the first active material powder 50 no longer rises to the upper portion of the fluidized bed reactor 100 and descends, the content of the first active material powder 50 to be fluidized may be more increased. Accordingly, the recovery efficiency of the lithium precursor may be further improved.

In some example embodiments, a maximum flow velocity of the reducing gas in the second region 112 may be the minimum fluidization rate or more of the second active material powder 60, and a maximum flow velocity of the reducing gas in the third region 113 may be the minimum fluidization rate or more of the third active material powder 70.

In this case, the second active material powder 60 and the third active material powder 70 having a large particle size may be more effectively fluidized. Accordingly, it is possible to effectively prevent a problem in which the cathode active material powder is not fluidized and deposited on the lower portion of the fluidized bed reactor 100.

In some example embodiments, the reducing gas may be injected into the fluidized bed reactor 100 at a flow velocity of 8 cm/s to 18 cm/s or more.

For example, when satisfying the above flow velocity range, scattering of the first active material powder having a small particle size may be prevented, and the third active material powder having a large particle size may be effectively fluidized by the first region having a large diameter located in the upper portion of the fluidized bed reactor. Thereby, the recovery efficiency of the lithium precursor may be improved.

According to some example embodiments, the fluidized bed reactor 100 for reducing a cathode active material of the present invention may include: a first connection section 121 which connects the first region 111 and the second region 112, and has a cross-sectional diameter decreasing from the first region 111 toward the second region 112; and a second connection section 122 which connects the second region 112 and the third region 113, and has a cross-sectional diameter decreasing from the second region 112 toward the third region 113.

In this case, the first connection section 121 and the second connection section 122 prevent the cross-sectional diameter of the reactor body 110 from rapidly changing, thereby preventing the flow velocity of the reducing gas within the reactor body 110 from being rapidly decreased. Accordingly, a problem in which the active material powder is deposited on a side surface of the reactor body 110 according to a decrease in the flow velocity of the reducing gas may be effectively prevented.

Referring to FIG. 3, the fluidized bed reactor for reducing a cathode active material of the present invention may further include gas injection ports 130 disposed on a side surface of the connection section 120. For example, the reducing gas, or the like may be injected through the gas injection ports 130. In this case, the gas injected from the gas injection ports 130 may effectively prevent the active material powder from being deposited on the side surface of the connection section 120.

According to some example embodiments, the gas injection ports 130 may be disposed on the side surface of the reactor body 110 to be inclined upward. In this case, due to the gas injection ports 130 disposed upward of the reactor body 110, the problem in which the cathode active material powders 50, 60 and 70 are deposited on the side surface of the connection section 120 may be more effectively prevented.

According to some example embodiments, an angle α formed by the side surface of the connection section 120 and the gas injection port 130 may be 45° to 90°. When the angle α formed by the side surface of the connection section 120 and the gas injection port 130 satisfies the above range, it is possible to more effectively prevent the problem in which the active material powder is deposited on the side surface of the connection section 120

Although the invention has been described by reference to specific examples it should be understood that the invention is not limited to the specific examples only and many other examples and variations thereof may be envisioned by the skilled person without departing from the scope of the invention as defined in the appended claims.

1. A method for recycling a lithium precursor comprising:
preparing a cathode active material powder comprising a plurality of cathode active material powders each one of the plurality of the cathode active material powders comprising lithium composite oxide particles having different particle sizes;
preparing a preliminary precursor mixture by reducing the cathode active material powders in a fluidized bed reactor comprising a reactor body whose cross-sectional diameter is decreased stepwise or gradually from an upper portion to a lower portion; and
recovering a lithium precursor from the preliminary precursor mixture.

2. The method for recycling a lithium precursor according to claim 1, wherein the cathode active material powders comprise a first active material powder, a second active material powder, and a third active material powder, which have different particle sizes, and
the reactor body comprises a first region where the first active material powder is fluidized, a second region where the second active material powder is fluidized, and a third region where the third active material powder is fluidized.

3. The method for recycling a lithium precursor according to claim 2, wherein the first region, the second region, and the third region are sequentially disposed from the upper portion of the reactor body.

4. The method for recycling a lithium precursor according to claim 3, wherein a cross-sectional diameter of the first region is greater than a cross-sectional diameter of the second region, and the cross-sectional diameter of the second region is greater than a cross-sectional diameter of the third region.

5. The method for recycling a lithium precursor according to claim 4, wherein a ratio of the cross-sectional diameter of the first region to the cross-sectional diameter of the third region is 4 to 16.

6. The method for recycling a lithium precursor according to claim 4, wherein a ratio of the cross-sectional diameter of the second region to the cross-sectional diameter of the third region is 2 to 4.

7. The method for recycling a lithium precursor according to claim 3, wherein a particle size of the first active material powder is smaller than a particle size of the second active material powder, and the particle size of the second active material powder is smaller than a particle size of the third active material powder.

8. The method for recycling a lithium precursor according to claim 7, wherein the particle size of the first active material powder is less than 10 μm, the particle size of the second active material powder is 10 μm to 100 μm, and the particle size of the third active material powder is 100 μm or more.

9. The method for recycling a lithium precursor according to claim 2, wherein the preparing the preliminary precursor mixture further comprises injecting a reducing gas into the fluidized bed reactor.

10. The method for recycling a lithium precursor according to claim 9, wherein a minimum flow velocity of the reducing gas in the first region is a terminal velocity or less of the first active material powder.

11. The method for recycling a lithium precursor according to claim 9, wherein a maximum flow velocity of the reducing gas in the second region is a minimum fluidization rate or more of the second active material powder, and a maximum flow velocity of the reducing gas in the third region is a minimum fluidization rate or more of the third active material powder.

12. The method for recycling a lithium precursor according to claim 9, wherein the reducing gas is injected into the fluidized bed reactor at a flow velocity of 8 cm/s to 18 cm/s.

13. The method for recycling a lithium precursor according to claim 2, wherein the fluidized bed reactor comprises:
a first connection section which connects the first region and the second region, and has a cross-sectional diameter decreasing from the first region to the second region; and
a second connection section which connects the second region and the third region, and has a cross-sectional diameter decreasing from the second region to the third region.

14. The method for recycling a lithium precursor according to claim 13, wherein the first connection section and the second connection section further comprise gas injection ports disposed on the side surfaces thereof.

15. The method for recycling a lithium precursor according to claim 14, wherein the gas injection ports are disposed on the side surface of the reactor body to be inclined upward.

16. The method for recycling a lithium precursor according to claim 14, wherein an angle formed by the side surfaces of the first connection section and the second connection section and the gas injection ports is 45° to 90°.

17. A fluidized bed reactor for reducing a cathode active material comprising:
a reactor body whose cross-sectional diameter is decreased stepwise or gradually from an upper portion to a lower portion;
an active material inlet through which a plurality of cathode active material powders including lithium composite oxide particles and having different particle sizes are injected into the reactor body; and
a gas inlet located at the lower portion of the reactor body and into which a reducing gas for fluidizing the active material powder is injected.

18. The fluidized bed reactor for reducing a cathode active material according to claim 17,
wherein the reactor body comprises three regions with different cross-sectional diameters, a first region where first active material powder can be fluidized, a second region where a second active material powder can be fluidized, and a third region where a third active material powder can be fluidized;
a first connection section which connects the first region and the second region, and has a cross-sectional diameter decreasing from the first region to the second region; and
a second connection section which connects the second region and the third region, and has a cross-sectional diameter decreasing from the second region to the third region, wherein the first active material powder, the second active material powder, and the third active material powder have different particle sizes.

19. The fluidized bed reactor for reducing a cathode active material according to claim 18, wherein the first connection section and the second connection section further comprise gas injection ports disposed on side surfaces thereof.
